(19) United States
(12) Patent Application Publication
(10) Pub. No.: US 2026/0291118 A1
(43) Pub. Date: Sep. 24, 2026

(54) TERMINAL BLOCK

(71) Applicant: Yazaki Corporation, Tokyo (JP)

(72) Inventors: Masatoshi YAMADA, Shizuoka (JP); Masato AKINO, Shizuoka (JP); Yasuhiro TANAKA, Shizuoka (JP); Yasuhiro OTSUTA, Shizuoka (JP); Sota ARAI, Shizuoka (JP); Yusuke TSUTAGAWA, Shizuoka (JP)

(73) Assignee: Yazaki Corporation, Tokyo (JP)

(21) Appl. No.: 19/537,634

(22) Filed: Feb. 12, 2026

(30) Foreign Application Priority Data
Mar. 18, 2025 (JP) 2025-043697

(51) Int. Cl. H01R 13/52; H01R 13/50; H01R 13/506

(52) U.S. Cl. CPC H01R 13/521; H01R 13/50; H01R 13/506

(57) ABSTRACT

A terminal block includes: a housing and a seal member. The housing includes: a busbar holding portion that holds a busbar extending in an axial direction; an attachment surface provided to abut on an attachment target; and an annular shaped recessed groove provided in an annular shape on the attachment surface on an outer side of the busbar holding portion around the axial direction. The seal member has an annular shape and is provided in the annular shaped recessed groove. The seal member includes a projection protruding toward a side wall surface of the annular shaped recessed groove.

### CROSS-REFERENCE TO RELATED APPLICATIONS

The present application claims priority to and incorporates by reference the entire contents of Japanese Patent Application No. 2025-043697 filed in Japan on Mar. 18, 2025.

### BACKGROUND OF THE INVENTION

### 1. Field of the Invention

The present invention relates to a terminal block.

### 2. Description of the Related Art

As a technique related to a conventional terminal block, for example, Japanese Patent Application Laid-open No. 2010-135218 discloses a terminal block including: a substantially tubular protrusion; and an annular shaped rubber seal gasket provided on an outer circumference of the protrusion. On an outer circumference of a tip end portion of the protrusion, an inclined surface whose diameter decreases toward the tip is provided in an annular shape. On the other hand, an opening edge of the rubber seal gasket on the protrusion side is provided with an inclined surface so as to be in sliding contact with the inclined surface of the protrusion.

In such a terminal block, for example, when the rubber seal gasket is assembled to the protrusion, the inner circumferential surface of the rubber seal gasket is expanded by the inclined surfaces of the rubber seal gasket and the protrusion. At this time, when the resistance of sliding contact between the inclined surfaces is large, there is a difficulty in assembling the terminal block in some cases. There is still room for further improvement in the configuration for assembling the seal member such as a rubber seal gasket to the terminal block.

### SUMMARY OF THE INVENTION

The present invention has been made in view of the above circumstances, and an object of the present invention is to provide a terminal block to which a seal member can be appropriately assembled.

A terminal block according to one aspect of the present invention includes a housing; and a seal member, wherein the housing includes a busbar holding portion that holds a busbar extending in an axial direction, an attachment surface provided to intersect the axial direction so as to abut on an attachment target; and an annular shaped recessed groove annularly provided on the attachment surface on an outer side of the busbar holding portion around the axial direction, the seal member has an annular shape and being provided in the annular shaped recessed groove, the seal member includes a projection protruding toward a side wall surface of the annular shaped recessed groove, an opening edge of the annular shaped recessed groove connecting the attachment surface and the side wall surface is provided with a projection guide portion formed in a recessed shape and configured to guide the projection, and the projection guide portion is located on a line passing through the projection in the axial direction and includes a guide inclined portion which is inclined so as to expand from the side wall surface toward the opening edge.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a state where a terminal block according to an embodiment is attached to an attachment target schematically illustrated;

FIG. 2 is an exploded perspective view illustrating the terminal block and the attachment target according to the embodiment;

FIG. 3 is a front view illustrating a seal member according to the embodiment;

FIG. 4 is an enlarged perspective view illustrating a projection guide portion according to the embodiment;

FIG. 5 is a cross-sectional view corresponding to a VII-VII cross section of FIG. 1, and is a cross-sectional view illustrating a state immediately before insertion of the seal member into an annular shaped recessed groove;

FIG. 6 is a cross-sectional view corresponding to a VII-VII cross section of FIG. 1, and is a cross-sectional view illustrating a state where a projection of a seal member abuts on a guide inclined portion of a projection guide portion of the annular shaped recessed groove; and

FIG. 7 is a cross-sectional view taken along line VII-VII of FIG. 1.

### DETAILED DESCRIPTION OF THE PREFERRED EMBODIMENTS

An embodiment according to the present invention will be described below in detail with reference to the drawings. Note that the present invention is not limited by the present embodiment. Moreover, components in the following embodiment include those easily interchangeable by those skilled in the art or substantially identical.

### Embodiment

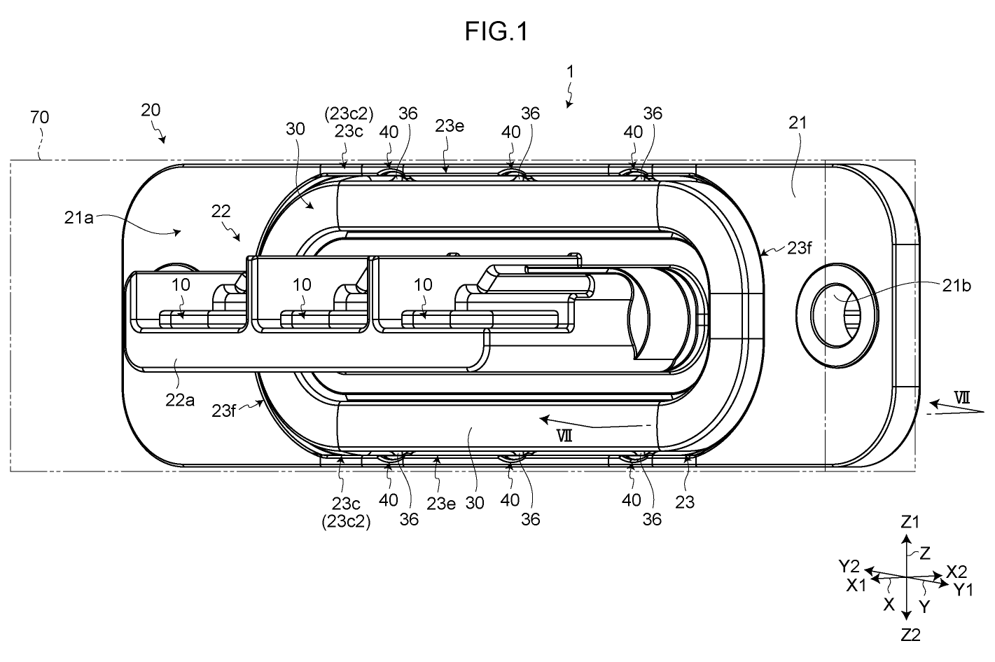

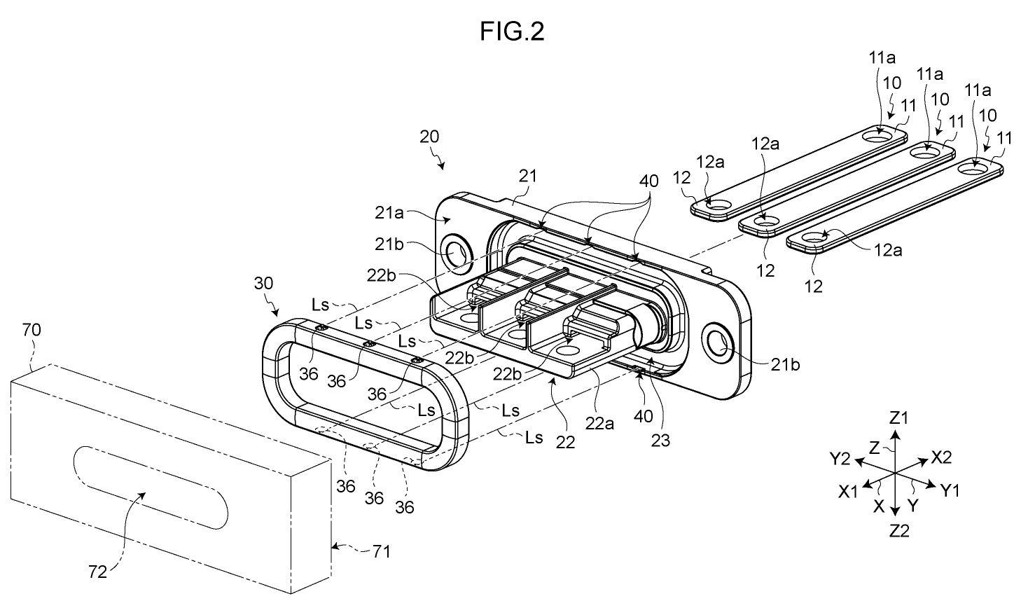

A terminal block 1 of the present embodiment illustrated in FIG. 1 is mounted on a vehicle such as an electric vehicle or a hybrid vehicle, for example, so as to be attached to an attachment target 70 indicated by a two-dot chain line and relay electrical connection between a first device and a second device (not illustrated). The terminal block 1 of the present embodiment includes a plurality of busbars 10. The plurality of busbars 10 each includes, on its one end, a first connection portion 11 (refer to FIG. 2) to which an external terminal of a first device is electrically connected. In the terminal block 1 of the present embodiment, the plurality of busbars 10 each includes, on its other end, a second connection portion 12 (refer to FIG. 2) to which an external terminal of a second device is electrically connected. The first device is one of a motor and an inverter, for example, and the second device is the other of the motor and the inverter, for example. The terminal block 1 is not limited to this example, and may be used for, for example, relaying between the first device or the second device and a wiring member, relaying between a wiring member and another wiring member, etc.

In the following description, a direction in which the busbars 10 extend is defined as an axial direction X, a direction orthogonal to the axial direction X and in which the plurality of busbars 10 are arrayed is defined as a width direction Y, and a direction orthogonal to the axial direction X and the width direction Y is defined as a height direction Z. In addition, one side in the axial direction X is defined as one side X1, and the other side is defined as the other side X2. Similarly, one side and the other side are defined as one side Y1 and the other side Y2 in the width direction Y, and one side and the other side are defined as one side Z1 and the other side Z2 in the height direction Z.

As illustrated in FIGS. 1 and 2, the terminal block 1 includes a housing 20 provided with the plurality of busbars 10. The housing 20 is provided with a seal member 30. The seal member 30 is also referred to as a seal gasket, and is formed of an elastically deformable material such as rubber or resin. The busbar 10 is a terminal fitting formed of a conductive metal material, and is electrically and mechanically connected to the external terminal described above. In the terminal block 1, three busbars 10 are arrayed to be aligned in the width direction Y.

The busbar 10 includes a first connection portion 11 and a second connection portion 12, and is formed in a long rectangular plate shape elongated in the axial direction X. The first connection portion 11 is formed on the other side X2 of the busbar 10 in the axial direction X, while the second connection portion 12 is formed on the one side X1. In the neighborhood of the end on the other side X2 in the axial direction X of the first connection portion 11, a connection hole 11a penetrating in the height direction Z is provided. Similarly, in the neighborhood of the end on the one side X1 in the axial direction X of the second connection portion 12, a connection hole 12a penetrating in the height direction Z is provided. The first device described above is connected to the connection hole 11a of the first connection portion 11, while the second device described above is connected to the connection hole 12a of the second connection portion 12.

The housing 20 is formed of a material such as an insulating synthetic resin material, and includes a housing body 21, which is a body having a substantially long rectangular plate shape with its longitudinal direction aligned with the width direction Y. A surface on one side X1 in the axial direction X of the housing body 21 is a surface directed in the axial direction X, and is an attachment surface 21a, being a substantially flat surface that abuts on an attachment target surface 71 of the attachment target 70. In the neighborhood of each end on one side Y1 and the other side Y2 in the width direction Y of the housing body 21, an attachment hole 21b is provided individually. The attachment hole 21b is a hole penetrating in the axial direction X, and a bolt (not illustrated) is inserted into the attachment hole 21b to fix the terminal block 1 to the attachment target 70 via the attachment hole 21b.

In a substantially central portion of the housing body 21 of the housing 20 in the width direction Y, a busbar holding portion 22 is provided. The busbar holding portion 22 holds the plurality of busbars 10 extending in the axial direction X so as to orthogonally intersect the attachment surface 21a. When the terminal block 1 is attached to the attachment target 70, the busbar holding portion 22 is inserted into an insertion hole 72 formed in a substantially rounded long rectangular shape elongated in the width direction Y in the attachment target 70. The busbar holding portion 22 is provided with a busbar holding protrusion 22a protruding toward one side X1 in the axial direction X. The busbar holding protrusion 22a is formed in a substantially flat plate shape with the plate surface facing the height direction Z. The busbar holding portion 22 is provided with three busbar attachment portions 22b to which the individual busbars 10 are attached. In FIG. 2, the busbar attachment portion 22b is illustrated in a flat hole shape penetrating in the axial direction X. In the present embodiment, the busbar 10 is attached to the busbar attachment portion 22b by insert molding. The busbar holding protrusion 22a is provided with partition plates corresponding to the three busbars 10. In this manner, the busbar holding portion 22 holds the plurality of busbars 10 arrayed in the width direction Y.

On the attachment surface 21a on the outer side of the busbar holding portion 22 around the axial direction X, there is provided an annular shaped recessed groove 23 in which a recessed groove is formed in an annular shape so as to surround the busbar holding portion 22. The annular shaped recessed groove 23 is formed in a long annular shape elongated in the width direction Y, that is, the direction in which the plurality of busbars 10 are arrayed. The seal member 30 is fitted into the annular shaped recessed groove 23. The seal member 30 is formed in a long annular shape elongated in the width direction Y in which the busbars 10 are arrayed.

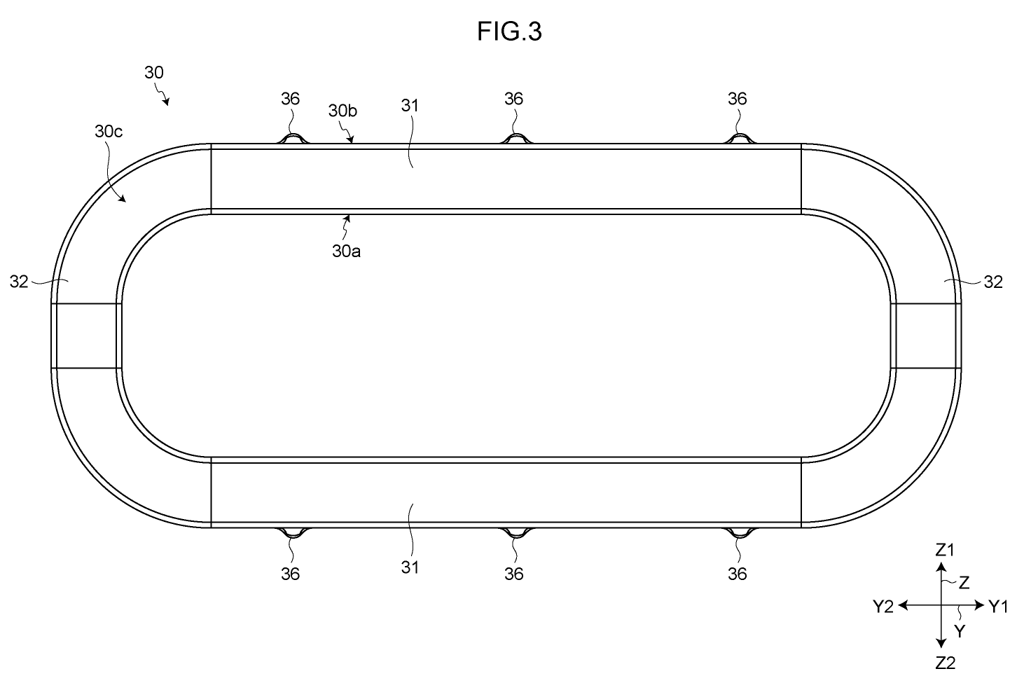

As illustrated in FIG. 3, the seal member 30 includes: an inner side surface 30a having an annular shape; and an outer side surface 30b having an annular shape. In the seal member 30, a long portion 31 which is a portion elongated substantially in a straight line shape in the width direction Y is provided on each of one side Z1 and the other side Z2 in the height direction Z. In addition, the seal member 30 is provided with two connection portions 32 which are formed to be curved so as to connect the end on one side Y1 and the end on the other side Y2 in the width direction Y of the two long portions 31. The annular shaped recessed groove 23 of the housing 20 is formed in substantially the same outer shape as the seal member 30 (long annular shape elongated in the direction in which the busbars 10 are arrayed). The annular shaped recessed groove 23 is provided with a long portion 23e individually on one side Z1 and the other side Z2 in the height direction Z. In addition, in the annular shaped recessed groove 23, a connection portion 23f curved to connect the ends of the two long portions 23e is provided on each of one side Y1 and the other side Y2 in the width direction Y (refer to FIG. 1).

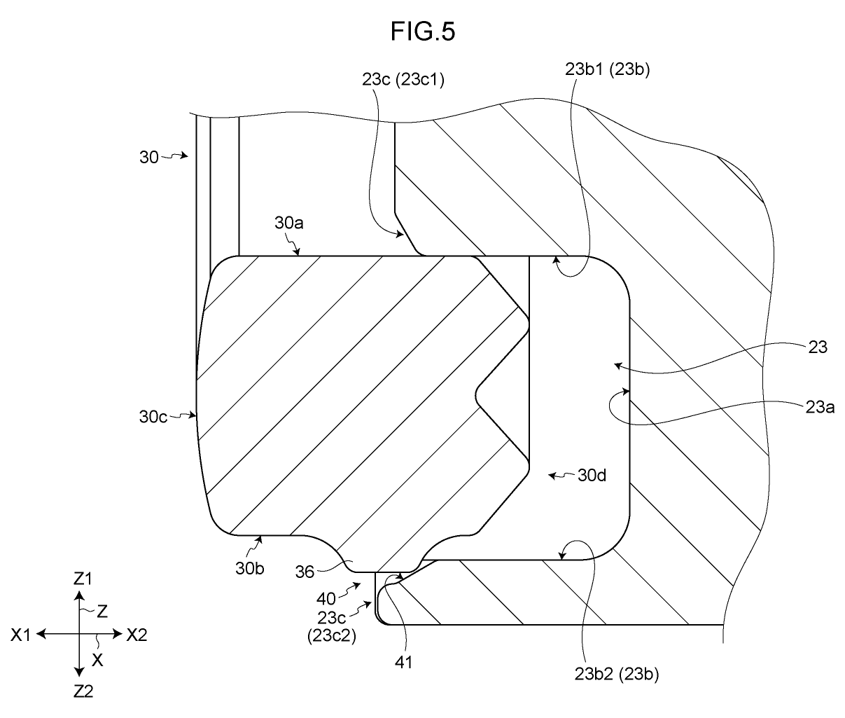

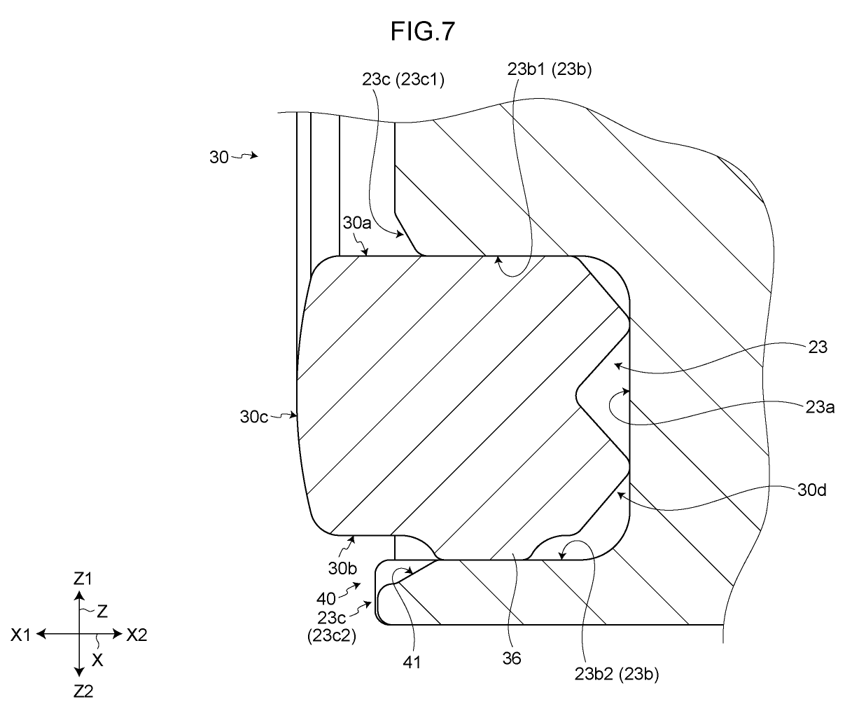

As illustrated in FIG. 3, three projections 36 are provided on each of an outer side surface 30b of the long portion 31 on one side Z1 and an outer side surface 30b of the long portion 31 on the other side Z2 in the height direction Z of the seal member 30. A total of six projections 36 are provided on the seal member 30. The projection 36 protrudes toward the side wall surface 23b (more specifically, an outer side wall surface 23b2 having an annular shape, refer to FIG. 7) of the annular shaped recessed groove 23. The three projections 36 are arranged at substantially equal intervals in the width direction Y. The projection 36 is formed in substantially a bump shape as viewed in the axial direction X. One side X1 and the other side X2 in the axial direction X, and one side Y1 and the other side Y2 in the width direction Y, in the projection 36, are formed in a recessed curved surface and connected to the outer side surface 30b (refer to also FIGS. 5 to 7).

The cross sections of the long portion 31 and the connection portion 32 of the seal member 30 are formed in substantially rectangular shapes. A surface of the seal member 30 on one side X1 in the axial direction X is a close contact surface 30c that comes into close contact with the attachment target surface 71 of the attachment target 70. The close contact surface 30c is formed in an annular shape around the axial direction X over the two long portions 31 and the two connection portions 32. As illustrated in FIGS. 5 to 7, a cross section of the close contact surface 30c has a gentle bump shape. On the other side X2 in the axial direction X of the seal member 30, a lip 30d having a cross section having a shape of two bumps is provided in a continuous annular shape.

As illustrated in FIGS. 5 to 7, the annular shaped recessed groove 23 is formed in a recessed groove shape having a bottom surface 23a and a side wall surface 23b rising from the bottom surface 23a. The side wall surface 23b includes: a side wall surface 23b1 on an inner side of the annular shape; and a side wall surface 23b2 on an outer side of the annular shape. The annular shaped recessed groove 23 opens on one side X1 in the axial direction X. An opening edge 23c of a portion where annular shaped recessed groove 23 opens includes: an opening edge 23c1 on an inner side of the annular shape; and an opening edge 23c2 on an outer side of the annular shape. The opening edge 23c is formed in an annular shape following the annular shaped recessed groove 23.

As illustrated in FIG. 1, a projection guide portion 40 is provided in the long portion 23e of the annular shaped recessed groove 23 corresponding to the long portion 31 of the seal member 30. The projection guide portion 40 guides the projection 36 of the seal member 30. The projection guide portion 40 is provided at the opening edge 23c2 on the outer side of the annular shape in the annular shaped recessed groove 23. The projection guide portions 40 are provided in a total of six, three in each of the long portions 31 at substantially equal intervals in the width direction Y. As illustrated in FIG. 2, each projection guide portion 40 is located on a line Ls passing through the projection 36 of the seal member 30 in the axial direction X. In other words, each projection guide portion 40 is provided in a one-to-one correspondence with each projection 36 of the seal member 30.

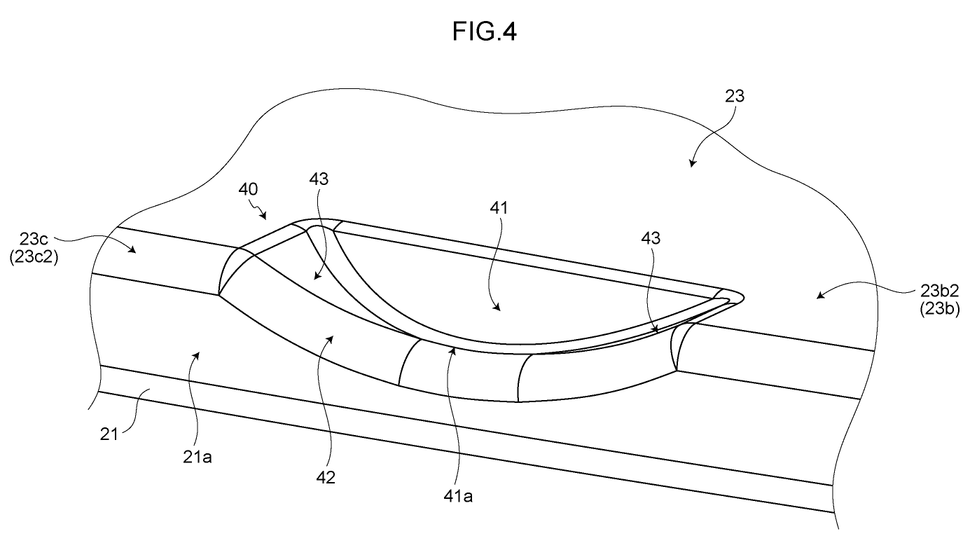

More specifically, as illustrated in FIG. 4, the projection guide portion 40 is provided on the opening edge 23c2 on the outer side of the annular shaped recessed groove 23 that connects the attachment surface 21a of the housing body 21 and the side wall surface 23b2 on the outer side which is the side wall surface 23b. The projection guide portion 40 has a guide inclined portion 41 being an inclined surface inclined so as to expand from the side wall surface 23b2 on the outer side toward the opening edge 23c2 on the outer side (refer to also FIGS. 5 to 7). The guide inclined portion 41 is formed in a flat surface shape. In addition, an inlet 42 at which the projection guide portion 40 is connected to the attachment surface 21a is formed in a recessed curved shape recessed in a protruding direction of the projection 36 of the seal member 30. Here, the inlet 42 is specifically a portion of an opening edge 23c2 where a protruding edge 41a of the guide inclined portion 41 and a connection inclined surface 43 described below are connected to the attachment surface 21a. The protruding direction of the projection 36 of the seal member 30 is the direction of the one side Z1 in the height direction Z in the long portion 31 on the one side Z1 in the height direction Z, and is the direction of the other side Z2 in the height direction Z in the long portion 31 on the other side Z2.

The inclined surface of the guide inclined portion 41 is formed in a substantially protruding curved shape in which the opening edge 23c2 side is protruding when viewed in a normal direction of the inclined surface. On the other hand, the opening edge 23c2 is formed in a rounded shape in which rounded chamfering is applied. The protruding edge 41a of the guide inclined portion 41 being a portion having a substantially protruding curved shape is in contact with the rounded chamfer endpoint of the opening edge 23c2 having a rounded shape on the annular shaped recessed groove 23 side. Individually on one side Y1 and the other side Y2 in the width direction Y of the protruding edge 41a, there is provided a connection inclined surface 43 that connects the guide inclined portion 41 and the opening edge 23c2 as the inlet 42. The connection inclined surface 43 is formed in a substantially recessed curved shape recessed in the protruding direction of the projection 36 when viewed from the one side X1 in the axial direction X.

The annular shaped recessed groove 23 and the seal member 30 formed in this manner are formed to be long in the longitudinal direction (that is, the width direction Y) intersecting the axial direction X. The projection guide portion 40 is provided on the opening edge 23c2 on the outer side of the annular shape in the longitudinal direction of the annular shaped recessed groove 23, that is, on each of the opening edges 23c2 on one side and the other side (that is, one side Z1 and the other side Z2 in the height direction Z) in the lateral direction of the annular shaped recessed groove 23. The projections 36 are provided on the outer side surface 30b in the annular shape in the longitudinal direction of the seal member 30 and on the outer side surfaces 30b on one side and the other side in the lateral direction of the seal member 30, individually. The plurality of projection guide portions 40 and the plurality of projections 36 are aligned in the lateral direction (height direction Z).

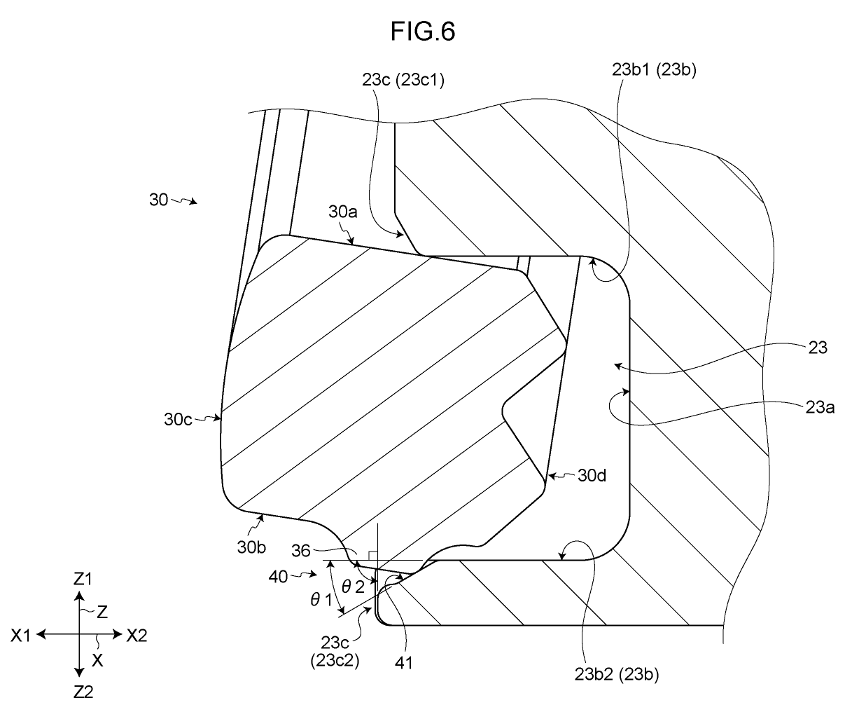

As illustrated in FIG. 5, the first step in assembling the seal member 30 to the terminal block 1 is directing the lip 30d of the seal member 30 to the annular shaped recessed groove 23 side of the housing 20 (housing body 21), and bringing the seal member 30 close to the annular shaped recessed groove 23 from the one side X1 in the axial direction X. When the seal member 30 is inserted into the annular shaped recessed groove 23, the projection 36 abuts on the guide inclined portion 41 of the projection guide portion 40, as illustrated in FIG. 6. This causes the inner side of the annular shape in the seal member 30, which is the side on which the projection 36 is not provided, to first enter the annular shaped recessed groove 23. Accordingly, the seal member 30 is inclined such that the inner side of the annular shape is located on the other side X2 in the axial direction X.

The subsequent step is pressing the outer side (for example, the close contact surface 30c in the neighborhood of the outer side surface 30b) of the inclined seal member 30 to further insert the seal member 30 into the annular shaped recessed groove 23. Since the guide inclined portion 41 is inclined in a direction in which the guide inclined portion 41 gradually decreases in diameter toward the other side X2 in the axial direction X, the projection 36 abutting on the guide inclined portion 41 is gradually compressed by the guide inclined portion 41. Therefore, the seal member 30 can be assembled to the annular shaped recessed groove 23 with a light pressing force.

Here, the inner diameter of the seal member 30 (inner side surface 30a) is formed to be smaller than the inner diameter of the annular inner side wall surface 23b1 of the annular shaped recessed groove 23. Accordingly, by pressing the outer side of the inclined seal member 30 and inserting the seal member 30 into the annular shaped recessed groove 23, the inner side surface 30a of the seal member 30 is spread out following the side wall surface 23b1 on the inner side of the annular shaped recessed groove 23. In addition, even when the projection 36 deviates in the width direction Y at the time of insertion of the seal member 30 into the annular shaped recessed groove 23, the projection 36 is guided by the inlet 42 and the connection inclined surface 43 of the projection guide portion 40 to the guide inclined portion 41 and guided to a regular attachment position.

In this manner, in the seal member 30, as illustrated in FIG. 7, the inner side surface 30a of the seal member 30 and the side wall surface 23b1 on the inner side of the annular shaped recessed groove 23 come into close contact with each other, and the lip 30d abuts on the bottom surface 23a. At this time, since the projection 36 is compressed, the seal member 30 does not easily escape from the annular shaped recessed groove 23 due to the repulsive force of the seal member 30. Therefore, even if the terminal block 1 to which the seal member 30 is assembled receives vibration due to transportation or the like, the seal member 30 would not be easily detached from the annular shaped recessed groove 23. In addition, when the terminal block 1 is attached to the attachment target 70 such that the attachment target surface 71 of the attachment target 70 abuts on the attachment surface 21a, the seal member 30 is crushed to achieve a close contact between the close contact surface 30c and the attachment target surface 71, the inner side surface 30a and the side wall surface 23b1, and the lip 30d and the bottom surface 23a, allowing the busbar holding portion 22 inside the seal member 30 to be sealed.

The terminal block 1 described above includes: the housing 20 and the seal member 30. The housing 20 includes: the busbar holding portion 22 that holds the busbar 10 extending in the axial direction X; the attachment surface 21a provided to intersect the axial direction X so as to abut on the attachment target 70; and the annular shaped recessed groove 23 provided in an annular shape on the attachment surface 21a on the outer side of the busbar holding portion 22 around the axial direction X. The seal member 30 has an annular shape and is provided in the annular shaped recessed groove 23. The seal member 30 includes the projection 36 protruding toward the side wall surface 23b2 on the outer side, which is the side wall surface 23b of the annular shaped recessed groove 23. The opening edge 23c2 on the outer side of the opening edge 23c of the annular shaped recessed groove 23 connecting the attachment surface 21a and the side wall surface 23b2 is provided with the projection guide portion 40 formed in a recessed shape and configured to guide the projection 36. The projection guide portion 40 is located on the line Ls passing through the projection 36 in the axial direction X and includes the guide inclined portion 41 which is inclined so as to expand from the side wall surface 23b2 toward the opening edge 23c2.

With this configuration, even if the seal member 30 has the projection 36 that can be compressed to be able to temporarily hold the seal member 30 in the annular shaped recessed groove 23, the projection 36 is gradually compressed by the guide inclined portion 41 of the projection guide portion 40 at the time of assembly. Therefore, the seal member 30 can be pressed to be assembled to the annular shaped recessed groove 23 without requiring a strong force, making it possible to appropriately assemble the seal member 30.

Specifically, as illustrated in FIG. 6, in assembling the seal member 30, the projection 36 abuts on the guide inclined portion 41 having an inclined surface angle θ1 (θ1<90 degrees). Here, in a case where the projection guide portion 40 is not provided, for example, the projection 36 abuts on the attachment surface 21a having an inclined surface angle θ2 (θ2=90 degrees). Therefore, the insertion angle of the seal member 30 is gentler at the inclined surface angle θ1 of the present embodiment than at the inclined surface angle θ2. Therefore, according to the present embodiment, the force for inserting the seal member 30 is reduced as compared with the case where the projection 36 abuts on the attachment surface 21a having the inclined surface angle θ2.

The projection 36 is formed in a bump shape, and the inlet 42 where the projection guide portion 40 is connected to the attachment surface 21a is formed in a recessed curved shape recessed in the protruding direction of the projection 36. With this configuration, even when the projection 36 deviates in the width direction Y and enters the projection guide portion 40, the projection 36, which has a bump shape, is aligned at the center of the recessed curve by the inlet 42 having a recessed curved shape and the connection inclined surface 43 connected to the inlet 42, making it possible to appropriately assemble the seal member 30 to the annular shaped recessed groove 23.

The projection guide portion 40 is provided at the opening edge 23c2 on the outer side of the annular shape of the annular shaped recessed groove 23, and the projection 36 is provided on the outer side surface 30b in the annular shape of the seal member 30. With this configuration, as compared with the case where the annular inclined surface is provided in the opening edge 23c2 on the outer side of the annular shaped recessed groove 23, the guide inclined portion 41 of the projection guide portion 40 can increase the thickness of the outer wall of the annular shaped recessed groove 23 (the outer wall corresponding to the long portion 23e of the annular shaped recessed groove 23 in which the side wall surface 23b2 is formed) to have enhanced rigidity. Furthermore, as compared with a case where the opening edge 23c2 on the outer side of the annular shaped recessed groove 23 is provided with the annular inclined surface, the area of the attachment surface 21a on the outer side of the annular shaped recessed groove 23 can be increased, making it possible to assemble the terminal block 1 onto the attachment target 70 in a stable posture.

Furthermore, the annular shaped recessed groove 23 and the seal member 30 are formed to be long in the longitudinal direction intersecting the axial direction X, the projection guide portion 40 is provided on the opening edge 23c on the outer side of the annular shape in the longitudinal direction of the annular shaped recessed groove 23, that is, the opening edges 23c2 on one side and the other side in the lateral direction of the annular shaped recessed groove 23, individually, the projection 36 is provided on the annular outer side surface 30b in the longitudinal direction of the seal member 30, that is, the outer side surface 30b on one side and the other side in the lateral direction of the seal member 30, individually, and the plurality of projection guide portions 40 and the plurality of projections 36 are provided to be aligned in the lateral direction.

With this configuration, the projection 36 is provided in the longitudinal direction that is relatively easily twisted in the terminal block 1 including the busbar holding portion 22 that holds the busbars 10 arrayed in one direction (for example, the width direction Y), it is possible to reduce twisting or the like of the seal member 30. In addition, since the plurality of projections 36 and the plurality of projection guide portions 40 are aligned in the lateral direction, it is possible to press the seal member 30 in a well-balanced manner, achieving appropriate assembly of the seal member 30.

Note that the terminal block according to the above-described embodiment of the present invention is not limited to the above-described embodiment, and various modifications can be made within the scope described in the claims.

In the above description, the projection 36 is provided on the outer side surface 30b of the seal member 30, and the projection guide portion 40 is provided on the opening edge 23c2 on the outer side of the annular shaped recessed groove 23. However, for example, the projection 36 may be provided on the inner side surface 30a of the seal member 30, and the projection guide portion 40 may be provided on the opening edge 23c1 on the inner side of the annular shaped recessed groove 23.

The terminal block according to the present embodiment may be configured by appropriately combining the components of the above-described embodiment and modifications.

The terminal block according to the present embodiment has an effect that the seal member can be appropriately assembled.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing; and
a seal member, wherein
the housing includes a busbar holding portion that holds a busbar extending in an axial direction, an attachment surface provided to intersect the axial direction so as to abut on an attachment target; and an annular shaped recessed groove annularly provided on the attachment surface on an outer side of the busbar holding portion around the axial direction,
the seal member has an annular shape and being provided in the annular shaped recessed groove,
the seal member includes a projection protruding toward a side wall surface of the annular shaped recessed groove,
an opening edge of the annular shaped recessed groove connecting the attachment surface and the side wall surface is provided with a projection guide portion formed in a recessed shape and configured to guide the projection, and
the projection guide portion is located on a line passing through the projection in the axial direction and includes a guide inclined portion which is inclined so as to expand from the side wall surface toward the opening edge.

2. The terminal block according to claim 1, wherein
the projection is formed in a bump shape, and
an inlet where the projection guide portion is connected to the attachment surface is formed in a recessed curved shape recessed in a protruding direction of the projection.

3. The terminal block according to claim 1, wherein
the projection guide portion is provided at the opening edge on an outer side of the annular shape of the annular shaped recessed groove, and
the projection is provided on the outer side surface of the annular shape of the seal member.

4. The terminal block according to claim 2, wherein
the projection guide portion is provided at the opening edge on an outer side of the annular shape of the annular shaped recessed groove, and
the projection is provided on the outer side surface of the annular shape of the seal member.

5. The terminal block according to claim 1, wherein
the annular shaped recessed groove and the seal member are formed to be long in a longitudinal direction intersecting the axial direction,
the projection guide portion is provided at each of the opening edge on the outer side of the annular shape in the longitudinal direction of the annular shaped recessed groove, that is, on one side and the other side in the lateral direction of the annular shaped recessed groove,
the projection is provided on the outer side surface of the annular shape of the seal member in the longitudinal direction, that is, on the outer side surfaces on one side and the other side in the lateral direction of the seal member, individually, and
the plurality of projection guide portions and the plurality of projections are provided to be aligned in the lateral direction.

6. The terminal block according to claim 2, wherein
the annular shaped recessed groove and the seal member are formed to be long in a longitudinal direction intersecting the axial direction,
the projection guide portion is provided at each of the opening edge on the outer side of the annular shape in the longitudinal direction of the annular shaped recessed groove, that is, on one side and the other side in the lateral direction of the annular shaped recessed groove,
the projection is provided on the outer side surface of the annular shape of the seal member in the longitudinal direction, that is, on the outer side surfaces on one side and the other side in the lateral direction of the seal member, individually, and
the plurality of projection guide portions and the plurality of projections are provided to be aligned in the lateral direction.
